(19) United States
(12) Patent Application Publication
(10) Pub. No.: US 2026/0028124 A1
(43) Pub. Date: Jan. 29, 2026

(54) COMPOSITE SHELL AIRCRAFT SEAT ASSEMBLY

(71) Applicant: B/E Aerospace, Inc., Winston-Salem, NC (US)

(72) Inventors: Glenn A. Johnson, Rural Hall, NC (US); Alen D. Wyss, Avon, CT (US); Paolo Ballocchi, Newcastle (GB)

(21) Appl. No.: 18/787,721

(22) Filed: Jul. 29, 2024

(51) Int. Cl. B64D 11/06

(52) U.S. Cl. CPC B64D 11/0648

(57) ABSTRACT

A composite seat shell may include a seat pan section and seatback section. In some instances, the composite seat shell may further include a leg panel section. The seat pan section and the seatback section may be integrated to form a seat bench. The seat bench may include a single composite member formed of one or more composite materials. A passenger load applied to the seat bench may be transferred from a seat belt shackle of the seat to a seat track on a floor via the seat bench of the composite seat shell.

### TECHNICAL FIELD

The subject matter disclosed herein relates to aircraft seats and, in particular, to a composite shell aircraft seat assembly.

### BACKGROUND

The build of the seat (and any included components within the build) may be required to meet guidelines and/or standards. For example, in select industries, the seat must be able to withstand inertial, dynamic, abuse, fatigue, and other load requirements as set forth by the industry guidelines and/or standards. Current seat frames are formed of metallic structures, however, such metallic structures increase the weight and cost of the seat.

### SUMMARY

A composite seat frame assembly for a seat is disclosed, in accordance with one or more embodiments of the present disclosure. In embodiments, the composite seat frame assembly includes a seat pan section. In embodiments, the composite seat frame assembly includes a seatback section, where the seat pan section and the seatback section are integrated to form a seat bench, and where the seat bench includes a single composite member formed of one or more composite materials, where a passenger load applied to the seat bench is transferred from a seat belt shackle of the seat to a seat track on a floor.

In some embodiments, the composite seat frame assembly may further include a leg panel section, where the leg panel section may be integrated with the seat pan section to form the seat bench.

In some embodiments, one or more composite legs may be at least one of coupled to or integrated with a portion of at least one of the seat pan section, the seatback section, or the leg panel section.

In some embodiments, the composite seat frame assembly may further include one or more side panels.

In some embodiments, the one or more side panels may be configured to couple to at least one of the seat pan section, the seat back section, or the leg panel section.

In some embodiments, the one or more side panels may be integrated with the seat pan section, the seat back section, and the leg panel section to form the seat bench.

In some embodiments, the one or more side panels may include one or more openings.

In some embodiments, the composite seat frame assembly may further include one or more structural beams.

In some embodiments, the one or more structural beams may have a shallow sinusoidal shape, where the one or more structural beams may be configured coupled to a rear portion of the seat pan section.

In some embodiments, one or more portions of the seatback section may include one or more gauged ribs to provide tailored structural reinforcement.

In some embodiments, the one or more gauged ribs may include one or more fiber reinforced composite ribs coupled to the one or more portion of the seatback section via robotic lay-up.

In some embodiments, the one or more composite materials of the single composite member may include carbon fiber including at least one of a thermoplastic matrix or a thermoset matrix.

In some embodiments, the single composite member of the seat bench may be fabricated via stamping.

In some embodiments, the leg panel section may include one or more kick panels.

An aircraft seat is disclosed, in accordance with one or more embodiments of the present disclosure. In embodiments, the aircraft seat includes a composite shell. In embodiment, the composite shell includes a seat pan section and a seatback section; where the seat pan section and the seatback section are integrated to form a seat bench; where the seat bench includes a single composite member formed of one or more composite materials. In embodiments, the aircraft seat includes a base assembly coupled to the seat bench, where the base assembly is configured to couple to a floor of an aircraft cabin, where the base assembly includes a leg sub-assembly including at least a front leg and a rear leg, where the front leg is configured to couple to a front portion of the seat pan section and a rear portion of the leg panel section, where the rear leg is configured to couple to a rear portion of the seat pan section, where a passenger load applied to the seat bench is transferred from a seat belt shackle of the aircraft seat to a seat track on the floor of the aircraft cabin.

In some embodiments, at least one of the front leg or the rear leg may be formed of the one or more composite materials or one or more additional composite materials.

In some embodiments, the composite shell may further include a leg panel section, where the leg panel section may be integrated with the seat pan section to form the seat bench.

In some embodiments, the composite shell may further include one or more side panels, where the one or more side panels may be configured to couple to at least one of the seat pan section, the seat back section, or the leg panel section.

In some embodiments, the aircraft seat may further include one or more structural beams, where the one or more structural cross beams may have a shallow sinusoidal shape, and where the one or more structural cross beams may be configured coupled to a rear portion of the seat pan section.

In some embodiments, one or more portions of the seatback section may include one or more gauged ribs to provide tailored structural reinforcement.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are examples and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 illustrates a simplified schematic view of a metallic seat frame assembly.

FIG. 2A illustrates a front perspective view of an aircraft seat including a composite shell aircraft seat assembly, in accordance with one or more embodiments of the disclosure.

FIG. 2B illustrates a rear perspective view of the aircraft seat including the composite shell aircraft seat assembly, in accordance with one or more embodiments of the disclosure.

FIG. 2C illustrates a top plan view of the aircraft seat including the composite shell aircraft seat assembly, in accordance with one or more embodiments of the disclosure.

FIG. 2D illustrates a bottom plan view of the aircraft seat including the composite shell aircraft seat assembly, in accordance with one or more embodiments of the disclosure.

FIG. 2E illustrates a front elevation view of the aircraft seat including the composite shell aircraft seat assembly, in accordance with one or more embodiments of the disclosure.

FIG. 2F illustrates a rear elevation view of the aircraft seat including the composite shell aircraft seat assembly, in accordance with one or more embodiments of the disclosure.

FIG. 2G illustrates a left side elevation view of the aircraft seat including the composite shell aircraft seat assembly, in accordance with one or more embodiments of the disclosure.

FIG. 2H illustrates a right side elevation view of the aircraft seat including the composite shell aircraft seat assembly, in accordance with one or more embodiments of the disclosure.

FIG. 2I illustrates a front perspective view of the aircraft seat including the composite shell aircraft seat assembly including load distribution arrows, in accordance with one or more embodiments of the disclosure.

FIG. 2J illustrates a rear perspective view of the aircraft seat including the composite shell aircraft seat assembly including load distribution arrows, in accordance with one or more embodiments of the disclosure.

FIG. 2K illustrates an isolated view of a bottom surface of the aircraft seat including the composite shell aircraft seat assembly including load distribution arrows, in accordance with one or more embodiments of the disclosure.

FIG. 3A illustrates a front perspective view of the composite shell aircraft seat assembly, in accordance with one or more embodiments of the disclosure.

FIG. 3B illustrates a rear perspective view of the composite shell aircraft seat assembly, in accordance with one or more embodiments of the disclosure.

FIG. 3C illustrates a top plan view of the composite shell aircraft seat assembly, in accordance with one or more embodiments of the disclosure.

FIG. 3D illustrates a bottom plan view of the composite shell aircraft seat assembly, in accordance with one or more embodiments of the disclosure.

FIG. 3E illustrates a front elevation view of the composite shell aircraft seat assembly, in accordance with one or more embodiments of the disclosure.

FIG. 3F illustrates a rear elevation view of the composite shell aircraft seat assembly, in accordance with one or more embodiments of the disclosure.

FIG. 3G illustrates a left side elevation view of the composite shell aircraft seat assembly, in accordance with one or more embodiments of the disclosure.

FIG. 4A illustrates a side view of the aircraft seat including the composite shell aircraft seat assembly including a structural cross beam, in accordance with one or more embodiments of the disclosure.

FIG. 4B illustrates a rear perspective view of the aircraft seat including the composite shell aircraft seat assembly including the structural cross beam, in accordance with one or more embodiments of the disclosure.

FIG. 5A illustrates a rear perspective view of the aircraft seat including the composite shell aircraft seat assembly including a structural cross beam, in accordance with one or more embodiments of the disclosure.

FIG. 5B illustrates an exploded view of one or more gauged ribs coupled to a portion of the composite shell aircraft seat assembly, in accordance with one or more embodiments of the disclosure.

### DETAILED DESCRIPTION OF THE INVENTION

Reference will now be made in detail to the subject matter disclosed, which is illustrated in the accompanying drawings.

Before explaining one or more embodiments of the disclosure in detail, it is to be understood the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one,” “one or more,” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of or sub-combination of two or more such features, along with any other features which may not necessarily be expressly described or inherently present in the instant disclosure.

Seats may include components such as, but not limited to, a seatback, a seat pan, and a base assembly (e.g., a primary structure). In select industries the build of the seat (and any included components within the build) may be required to meet guidelines and/or standards. For example, the select aircraft seats must be formed of a material ductile enough to absorb energy. Further, aircraft seats may be required to meet aviation guidelines and/or standards. For instance, the select aircraft seats may need to be configured in accordance with aviation guidelines and/or standards put forth by, but not limited to, the Federal Aviation Administration (FAA), the European Aviation Safety Agency (EASA) or any other flight certification agency or organization; the American National Standards Institute (ANSI), or any other standards setting organization or company; or any other guidelines agency or organization; or the like. The seat frame assembly may present difficulties such as, but not limited to, failing to meet load requirements (e.g., abuse, reliability, and dynamic load requirements (e.g., 4 G lateral and 16 g FWD load requirements)), or the like as set forth by the FAA in 14 C.F.R. Part 25, AIRWORTHINESS STANDARDS: TRANSPORT CATEGORY AIRPLANES)).

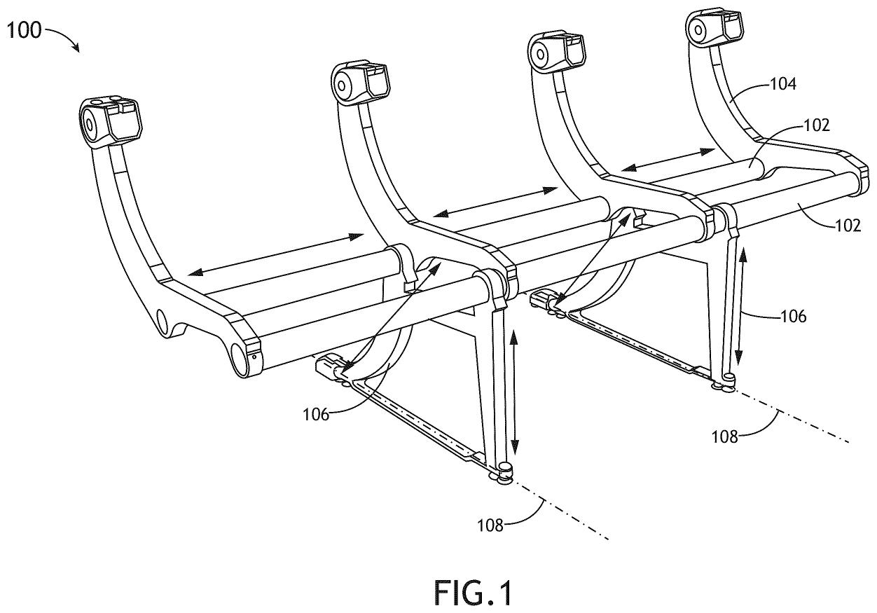

Conventional seat frames are often formed of metallic structures. In particular, as shown in FIG. 1, a conventional metallic structure 100 often includes twin beam cantilevered metallic beams 102. In this regard, loads are carried through the frame (e.g., beams 102, spreaders 104, legs 106, and the like) to seat tracks 108 on the floor, as shown by the arrows in FIG. 1. Such metallic structures 100 deliver a relatively high weight structure that is complex to assemble and includes a high-part count.

As such, it would be desirable to provide a composite shell aircraft seat assembly configured to address one or more shortcomings of the previous approaches. For assembly should provide a seat bench with a reduced part count and be light weight, while not compromising performance, safety, and cost. For example, the assembly may include a seat bench formed of a single composite member, where a seat pan section, a seatback section, and a leg panel section are integrated together to form said seat bench. For instance, the seat bench may be fabricated using thermoset or thermoplastic stamping. The seat bench may include one or more structural reinforcement members (e.g., thin gauged ribs) on areas of the seat bench where high loads are distributed (e.g., high lumbar area of the seatback section, or the like). For example, the one or more structural reinforcement members may be fabricated using robotic or in-situ layup techniques. The assembly should be configured in accordance with aviation guidelines and/or standards. For example, the assembly should meet load requirements (e.g., abuse, reliability, and dynamic load requirements (e.g., 16 G FWD, 14 G down, 4 G side load requirements)). Further, the assembly should have high energy absorption capabilities and meet ductility requirements.

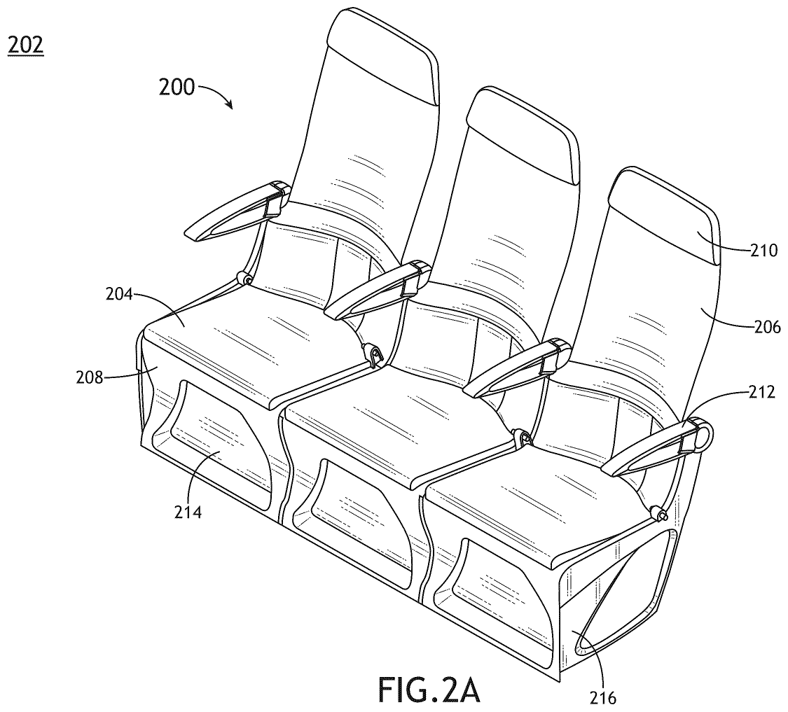

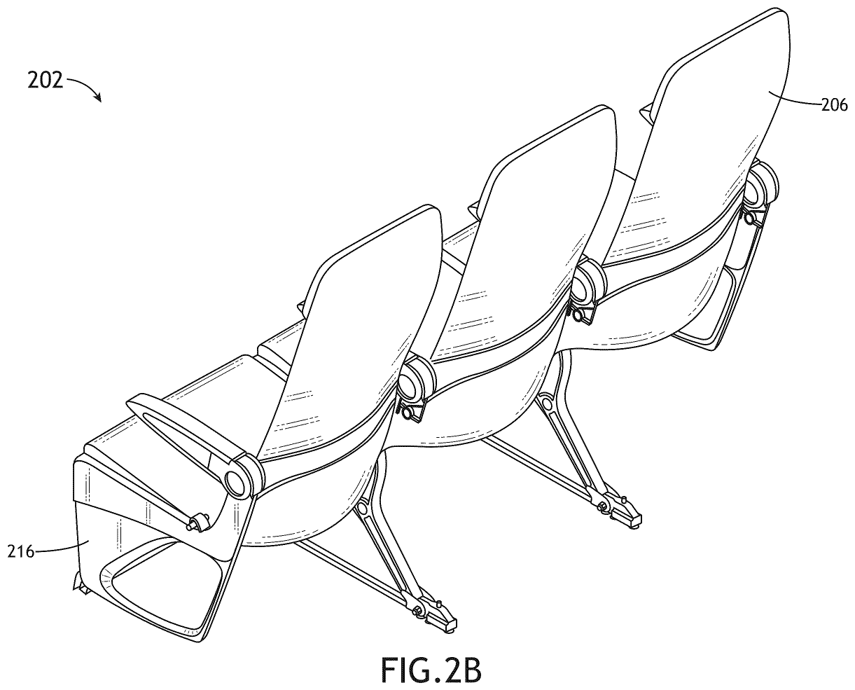

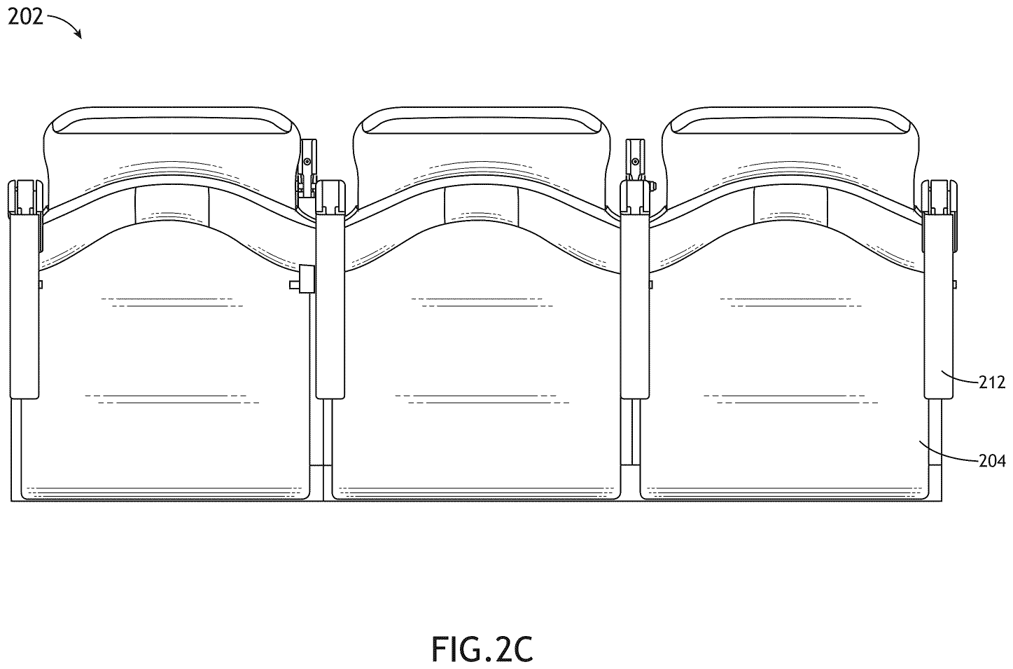

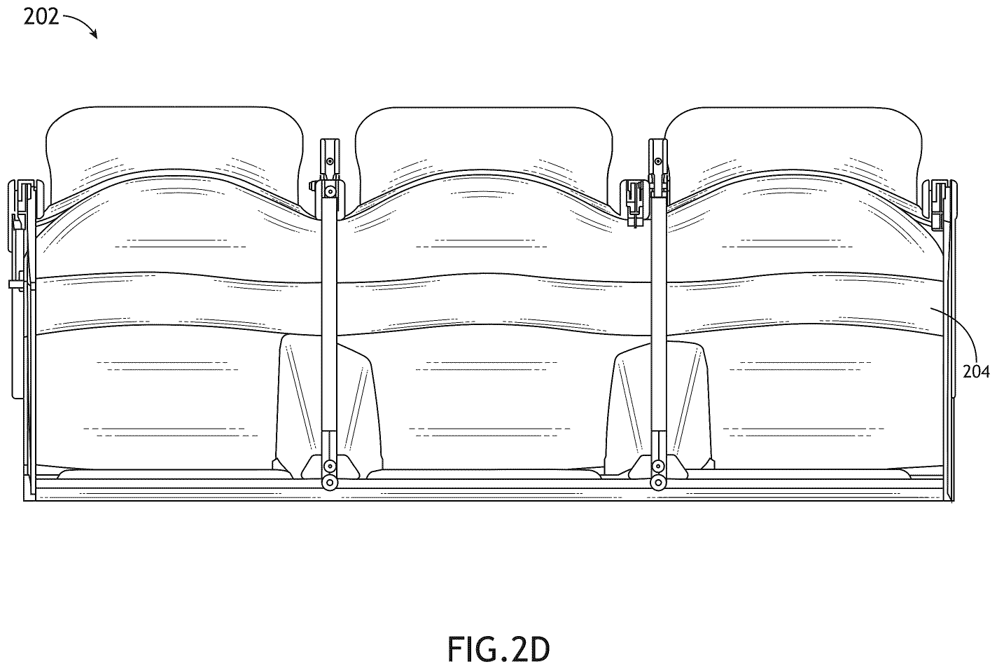

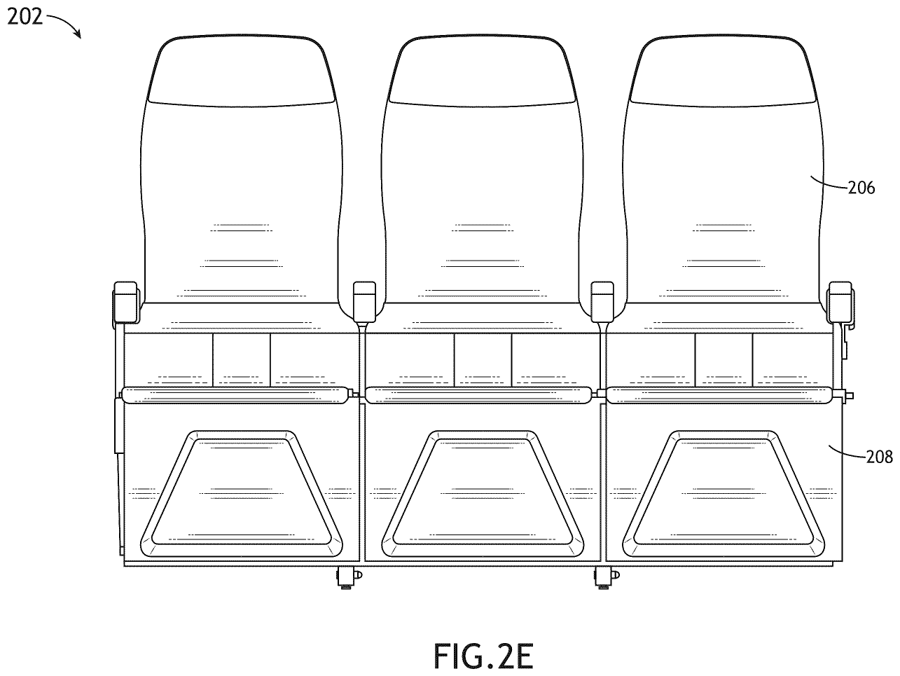

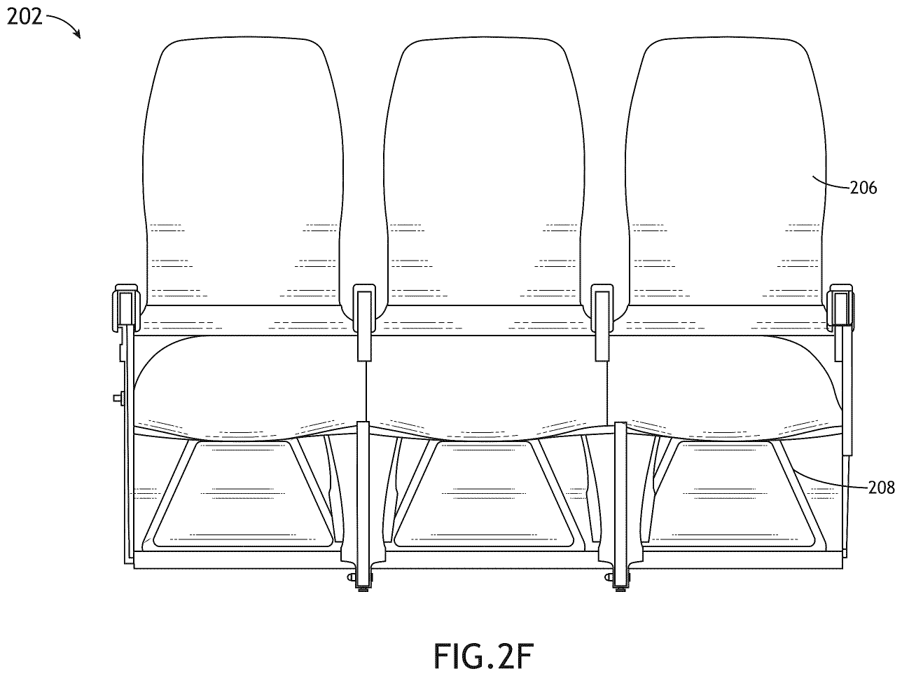

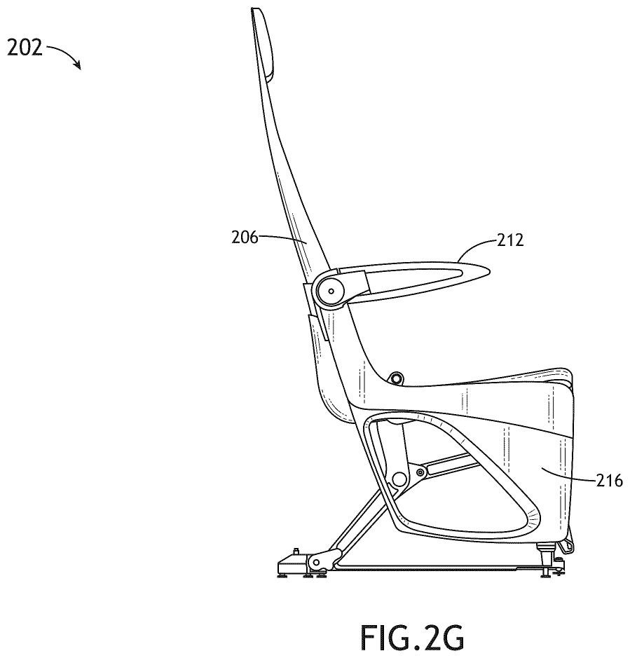

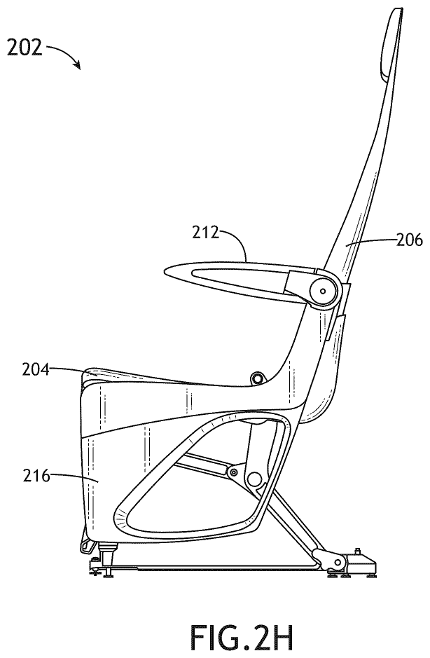

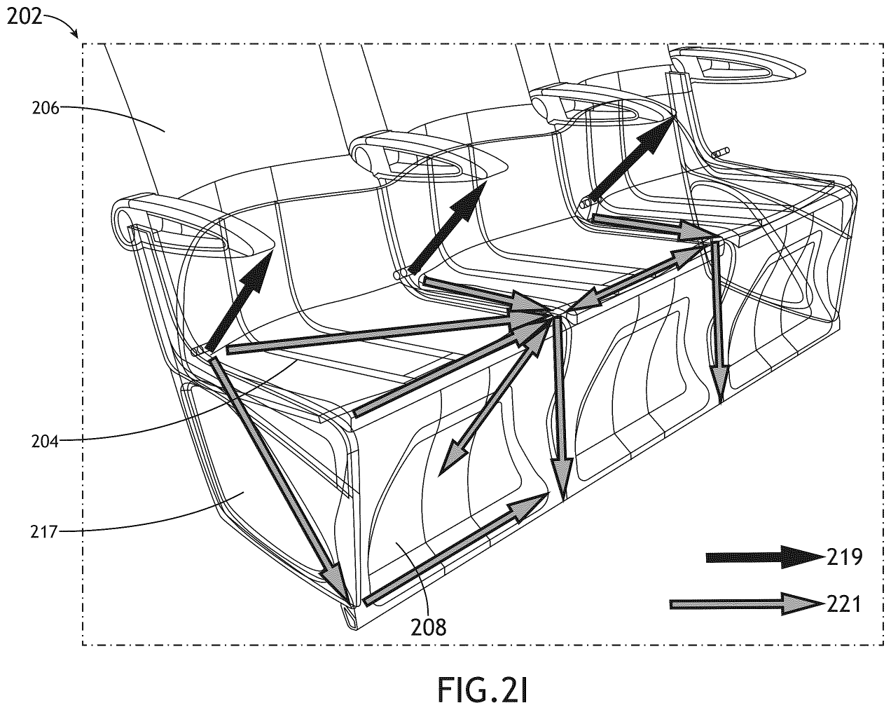

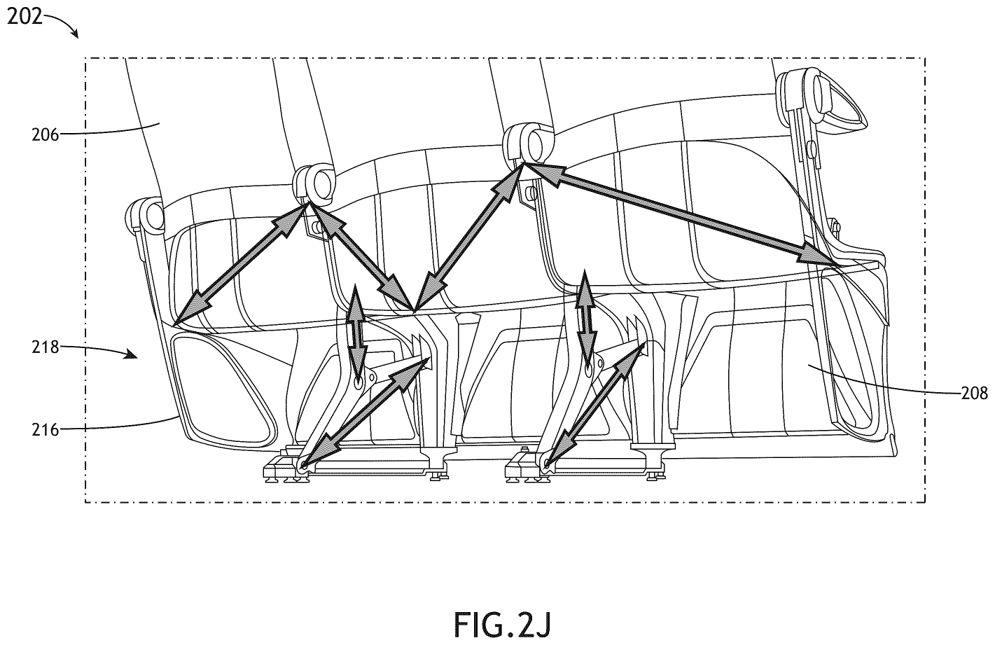

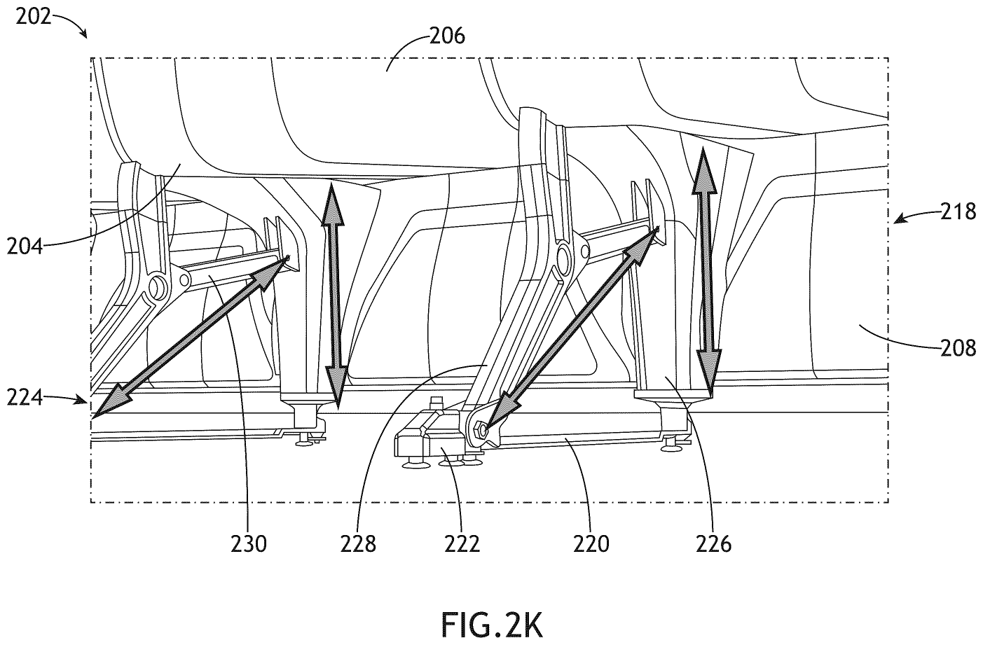

FIGS. 2A-5B in general illustrate a composite shell aircraft seat assembly 200 for an aircraft seat 202, in accordance with one or more embodiments of the disclosure.

Referring in general to FIGS. 2A-2K, the composite shell aircraft seat assembly 200 may be integrated within an aircraft seat 202 installed within an aircraft cabin. For example, as shown in FIG. 2A, the composite shell aircraft seat assembly may be integrated within a row of aircraft seats 202 installed within an aircraft cabin. By way of another example, the composite shell aircraft seat assembly may be integrated within an individual aircraft seat 202 installed within an aircraft cabin. It is noted that FIGS. 2A-2H are provided merely for illustrative purposes and shall not be construed as limiting the scope of the present disclosure.

The aircraft seat 202 may include, but is not limited to, a business class or first-class passenger seat, an economy-class passenger seat, a crew member seat, or the like. It is noted the terms “aircraft seats” and “passenger seats” may be considered equivalent, for purposes of the disclosure.

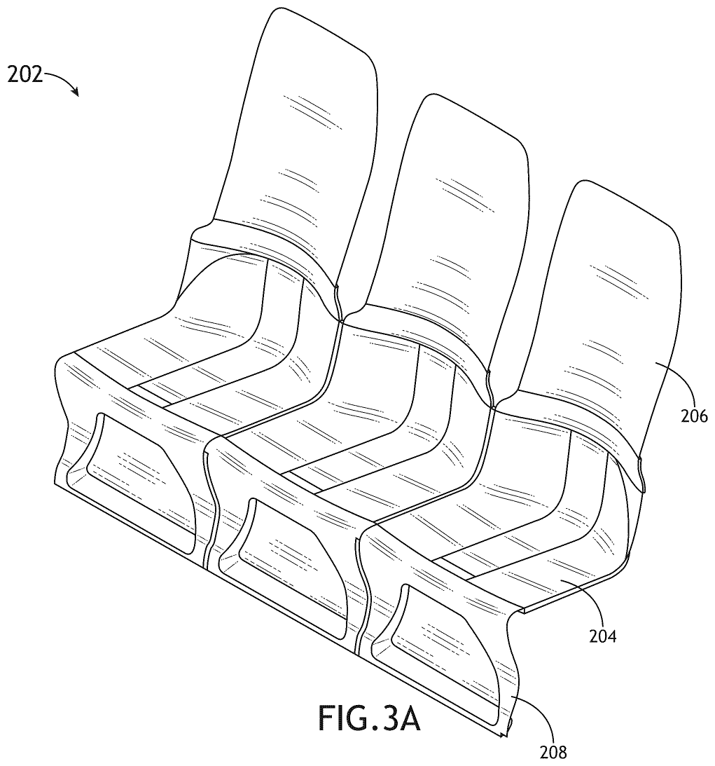

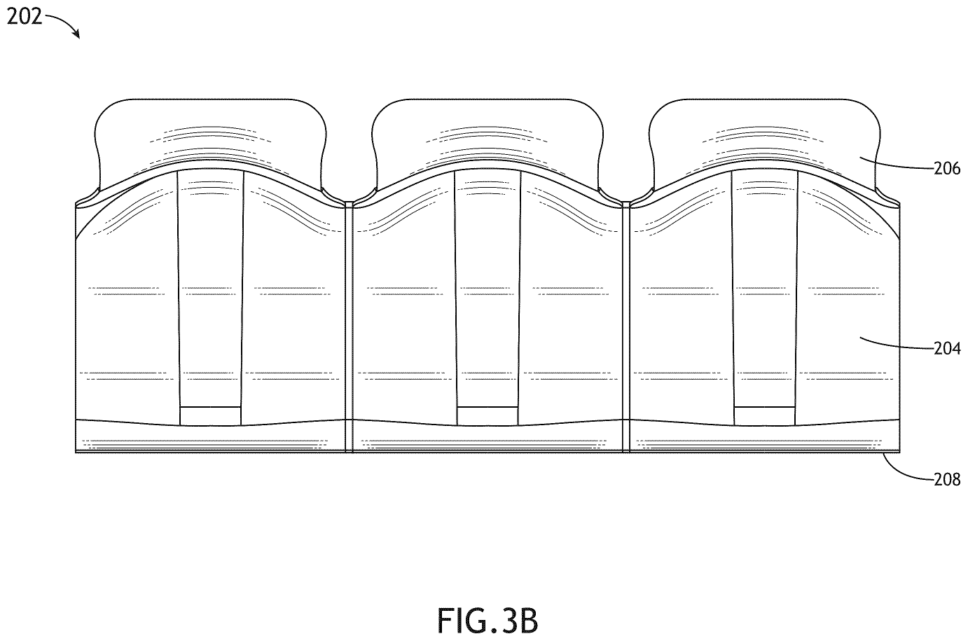

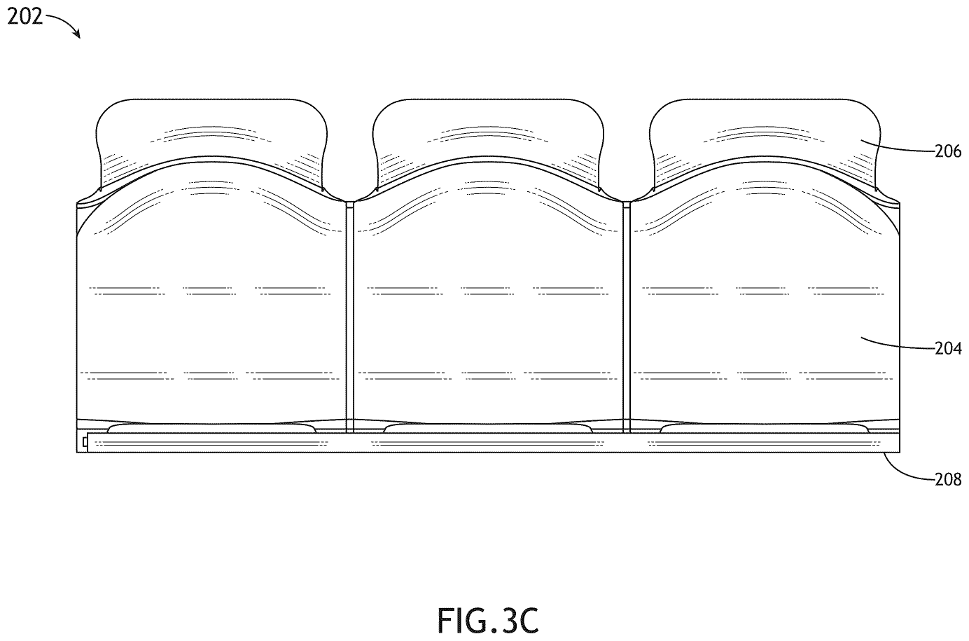

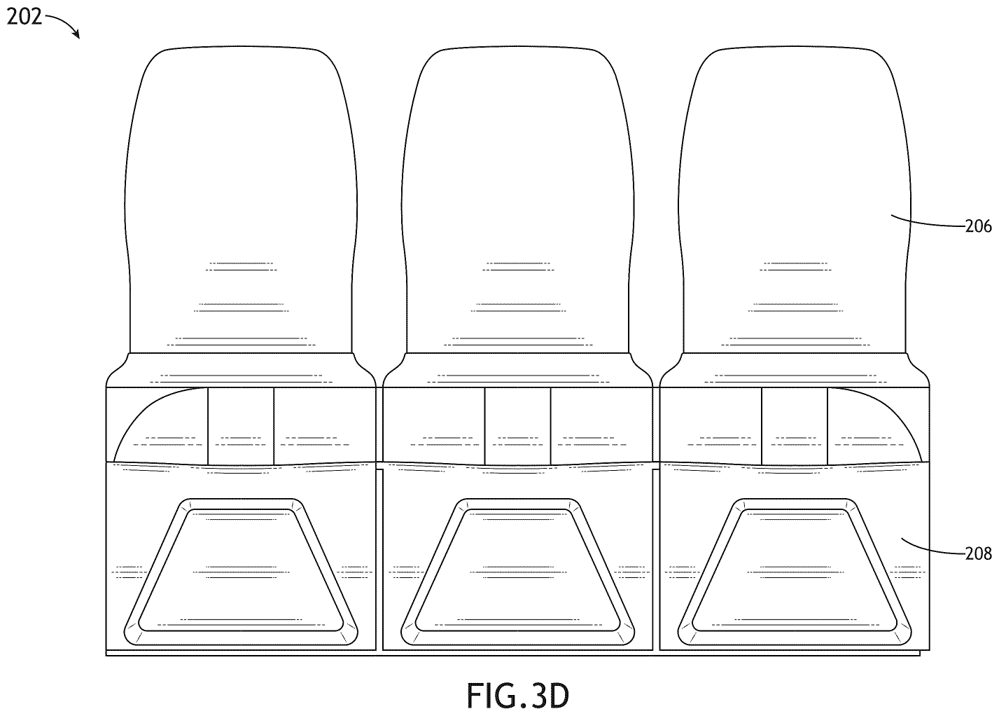

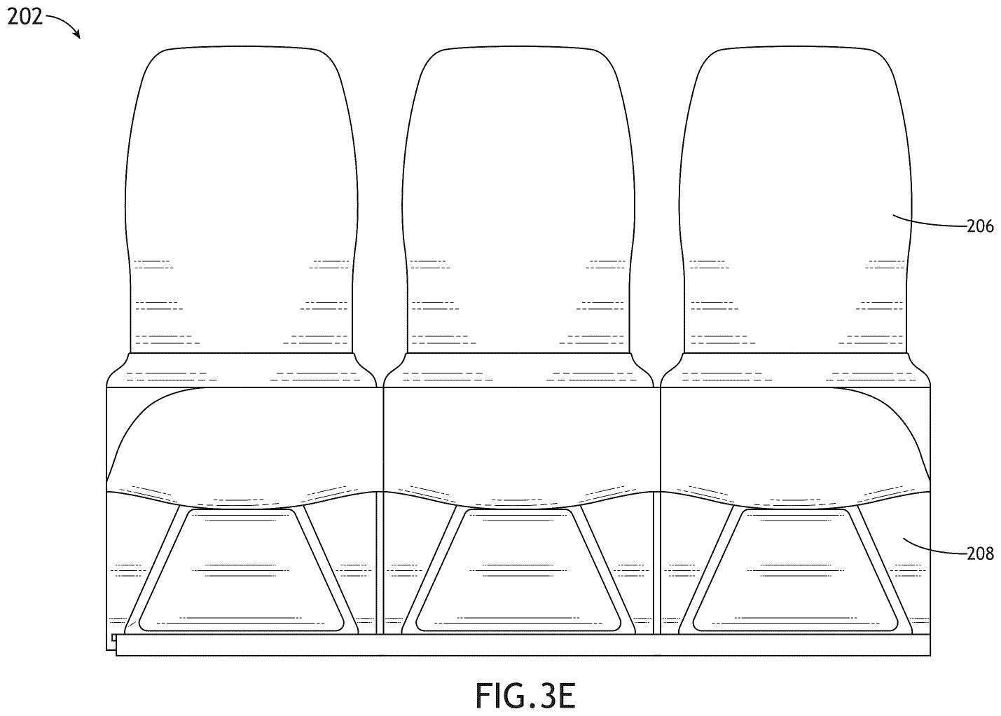

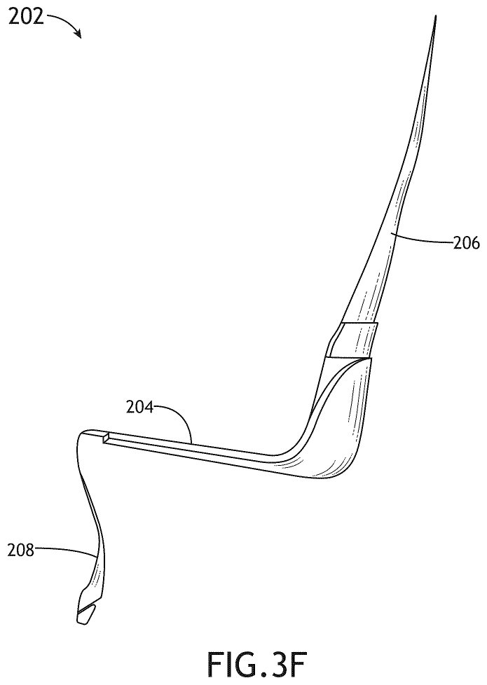

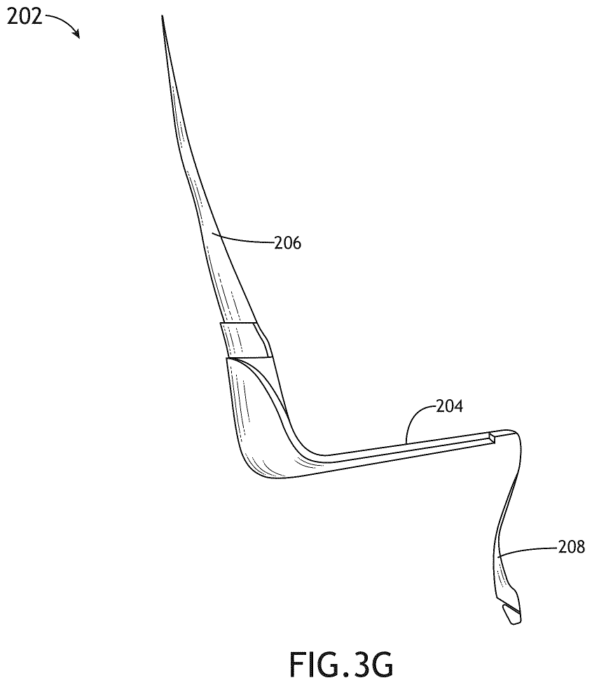

The composite shell aircraft seat assembly 200 may include a seat pan section 204, a seatback section 206, and a leg panel section 208. For example, as shown in FIGS. 3A-3G, the seat pan section 204, the seatback section 206, and the leg panel section 208 may be integrated to form a seat bench. For instance, the seat bench formed by the seat pan section 204, the seatback section 206, and the leg panel section 208 may be formed of a single composite member (i.e., single piece of composite material cured/welded into one integrated member).

The aircraft seat 202 including the composite shell aircraft seat assembly 200 may be a fixed aircraft seat. For example, the seat pan section 204 and the seatback section 206 of the composite shell aircraft seat assembly 200 may be fixed in a predetermined position. In this regard, a passenger occupying the aircraft seat 202 may be unable to recline the aircraft seat 202. Further, the leg panel section 208 may be fixed.

It is contemplated herein that the seat bench formed of the single composite member may be formed one or more thermoplastic composite materials such as, but not limited to, carbon fiber polyaryletherketone (PAEK) matrix, carbon fiber polyetherimide (PEI), polyphenylene sulfide (PPS) matrix, or the like, or one or more thermoset materials such as, but not limited to, carbon fiber epoxy, or the like. Further, it is contemplated herein that the single composite member forming the seat bench may be manufactured using one or more stamping processes. For example, multiple stamped components may then be then welded together, bonded together, fastened together, or the like.

As previously noted herein, the seat bench of the composite shell aircraft seat assembly 200 may provide a number of advantages over conventional seat frame assemblies. For example, the seat bench of the composite shell aircraft seat assembly 200 may reduce part count and decrease weight without compromising performance, safety, or cost.

The seat pan section 204 may couple to a seat pan cushion and the seatback section 206 may couple to a seatback cushion. For example, as shown in FIG. 2A, where the aircraft cabin includes a row of aircraft seats 202, each individual seat 202 may include a respective seat pan cushion and a seatback cushion coupled to a respective portion of the seat pan section 204 and the seatback section 206. By way of another example, although not shown, where the aircraft cabin includes a row of aircraft seats 202, a single seat pan cushion and a single seatback cushion may be coupled to the full top surface (or substantially full top surface) of the seat pan section 204 and the seatback section 206 of the seat bench. In this regard, the seat pan section 204 of the seat bench and the seatback section 206 of the seat bench may each include a bench-like cushion coupled to the respective surfaces.

The seatback section 206 may include a headrest 210. For example, the headrest 210 may be integrated within the seatback section 206. By way of another example, the headrest 210 may be a separate component coupled to the seatback section 206. For instance, the headrest 210 may be movable relative to the seatback section 206 of the aircraft seat 202 (e.g., adjustable, removable, or the like).

The aircraft seat 202 may include one or more arms 212. For example, the one or more arms 212 may be configured to couple to the seatback section 206.

The leg panel section 208 may include a kick panel 214 arranged on a front surface of the leg panel section 208. The kick panel 214 may be configured to protect the leg panel section 208 from damage (e.g., damage caused by passenger's feet/shoes, general maintenance/cleaning, or the like). For example, as shown in FIG. 2A, where the aircraft cabin includes a row of aircraft seats 202, each individual seat 202 may include a respective kick panel 214. By way of another example, although not shown, where the aircraft cabin includes a row of aircraft seats 202, a single kick panel section 214 may span a portion of the leg panel section 208.

The composite shell aircraft seat assembly 200 may include one or more side panels 216. For example, the one or more side panels 216 may be coupled to one or more portions of the seat bench. For instance, the one or more side panels 216 may be coupled to at least one of the seatback section 206, the seat pan section 204, or the leg panel section 208.

The one or more side panels 216 may function as a baggage bar to secure passenger items below the aircraft seat 202. For example, the one or more side panels 216 may prevent passenger items from entering the aisle, in accordance with aviation standards and/or guidelines.

The one or more side panels 216 may include one or more openings 217. Although FIGS. 2A-2K depict the side panel 216 including a specific shaped opening, it is contemplated herein that the one or more side panels 216 may include any configuration of opening. Further, it is contemplated herein that the one or more side panels 216 may include any number of openings. For example, the one or more side panels 216 may include a single opening. By way of another example, the one or more side panels 216 may include a plurality of openings. By way of another example, the one or more side panels 216 may include zero openings, such that the one or more side panels 216 may be a uniform, planar panel.

The composite shell aircraft seat assembly 200 may be coupled to a base assembly 218. For example, the composite shell aircraft seat assembly 200 of the aircraft seat 202 may be couplable to the base assembly 218. The base assembly 218 may be coupled to a floor of an aircraft cabin. For example, the base assembly 218 may be couplable to a floor of an aircraft cabin via one or more tracks (not shown), one or more track covers 220, and/or one or more floor fittings 222 (or track fasteners 222).

The base assembly 218 may include one or more leg sub-assemblies 224. Each leg sub-assembly 224 may include one or more legs. For example, each leg sub-assembly 224 may include a front leg 226 and a rear leg 228.

The one or more legs may be couplable to one or more portions of the composite shell aircraft seat assembly 200 of the aircraft seat 202. For example, the one or more front legs 226 may be couplable to a front portion of the composite shell aircraft seat assembly 200 of the aircraft seat 202. For instance, the one or more front legs 226 may be couplable to a portion of the seat pan section 204 and a portion of the leg panel section 208. In some instances, the one or more front legs 226 may be integrated with the seat bench. In this regard, the one or more front legs 226 may be integrated with a portion of the seat pan section 204 and a portion of the leg panel section 208 to form the one or more front legs 226.

By way of another example, the one or more rear legs 228 may be couplable to a rear portion of the composite shell aircraft seat assembly 200 of the aircraft seat 202. In one instance, the rear leg 228 may be couplable to a rear portion of the seat pan section 204. In another instance, the rear leg 228 may be coupled to a rear portion of the seatback section 206. In some instances, although not shown, the one or more rear legs 228 may be integrated with the seat bench. In this regard, the one or more rear legs 228 may be integrated with a portion of the seat pan section 204 and/or a portion of the seatback section 206 to form the one or more rear legs 228.

The one or more legs may be formed of a composite material. For example, as shown in FIGS. 2J-2K, the one or more front legs 226 (or the rear leg 228) may be formed of a composite material. In one instance, the composite material of the one or more front legs 226 may be the same composite material of the seat bench. In this regard, the one or more front legs 226 may be integrated with or coupled to the seat bench. By way of another example, the one or more front legs 226 and/or the rear leg 228 may be formed of a different composite material than the seat bench.

Composite leg assemblies are generally discussed in U.S. Patent Publication No. 2023/0174239, published Jun. 8, 2023, which is herein incorporated by reference in the entirety.

The one or more legs may be coupled together via one or more link beams 230. For example, the front leg 226 may include a connection portion configured to couple to a first end of the link beam 230 and the rear leg 228 may include a connection portion configured to couple to a second end of the link beam 230. In some instances, the leg sub-assembly 224 may be a single piece, such that the front leg 226, the rear leg 228, and the link beam 230 may be directly coupled to form a single piece. Further, in some instances, a portion of the leg sub-assembly 224 may be a single piece, such that the front leg 226, the rear leg 228, and/or the link beam 230 may be directly coupled to form a single piece.

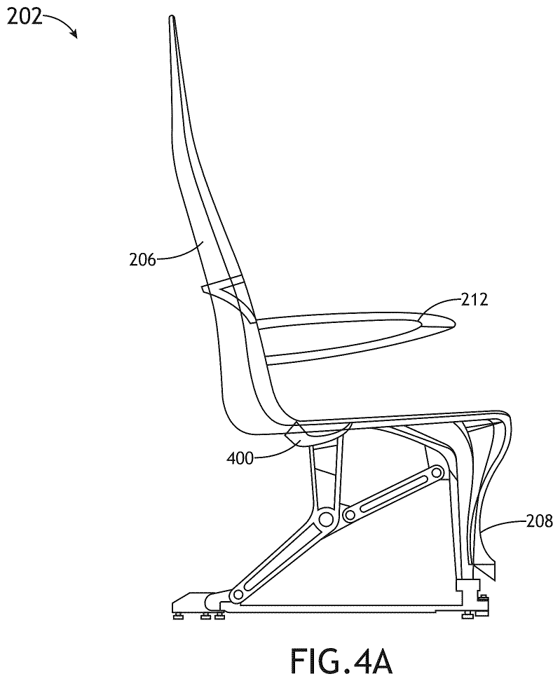

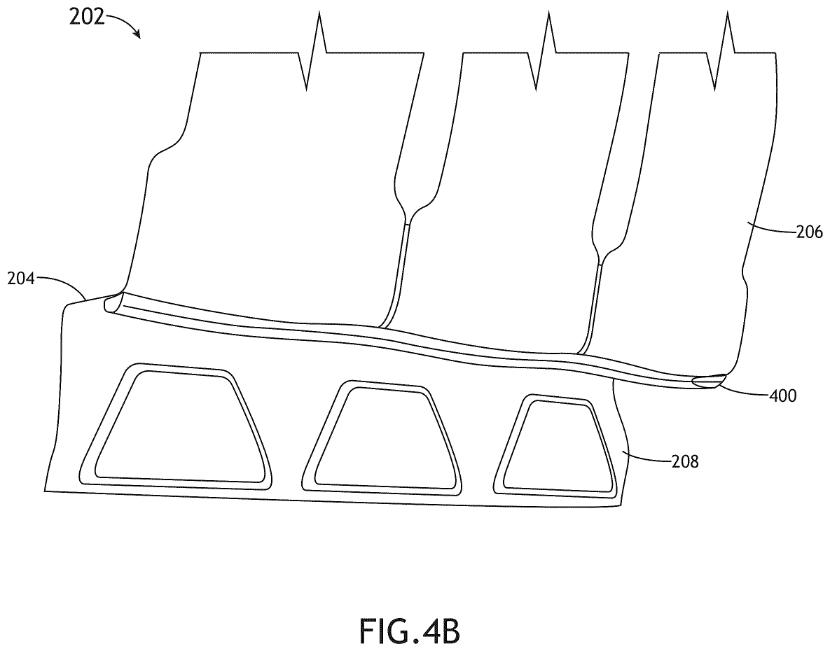

Referring to FIGS. 4A-4B, the one or more legs may be couplable to one or more structural beams 400. For example, the one or more rear legs 228 may be couplable to a structural beam of the one or more structural beams 400. For instance, the one or more legs may be configured to attach to the one or more structural beams 400 and secure to the one or more tracks located in the floor of the aircraft cabin via the one or more fittings. By way of another example, the one or more front legs 226 may be couplable to a structural beam of the one or more structural beams 400.

The one or more structural beams 400 may have a shallow sinusoidal shape. For example, as shown in FIG. 4B, the structural cross beams 400 may be configured to couple to a rear portion of the seat pan section 204. In this non-limiting example, the sinusoidal shape of the one or more structural beams 400 may correspond to the shape (or curvature) of the seat pan section 204.

Referring again to FIGS. 2J-2K, the aircraft seat 202 may transfer (or distribute) load in accordance with aviation standards and/or guidelines. For example, when a passenger load is applied to the aircraft seat 202, the load may be transferred accordingly. As shown in FIG. 2I, the seat bench of the composite shell aircraft seat assembly 200 may be configured to transfer the passenger load from a seat belt shackle, e.g., a seat belt shackle load 219, of the aircraft seat 202 to the seat tracks on the floor of the aircraft cabin. Further, the end bay and window end bay units may be configured to take the reacted loads 221 down to the lower valence and the one or more side panels 216 (e.g., baggage bar structure) and back to the seat leg topology. In this regard, the seat belt shackle loads 219 go through the seat bench of the composite shell aircraft seat assembly 200 and into the forward compressive area included in the lower valence, as shown by the reacted load arrows 221.

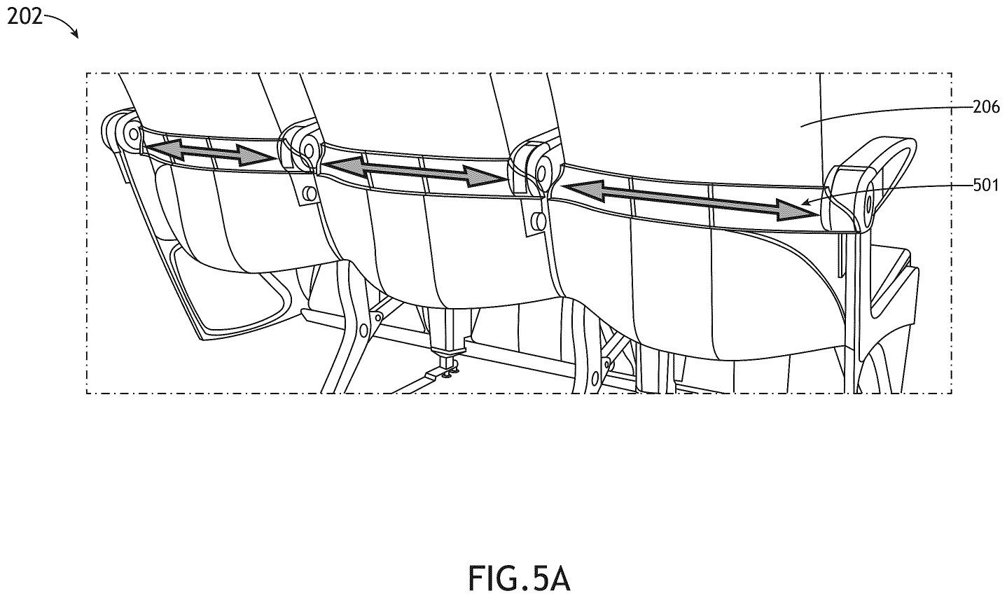

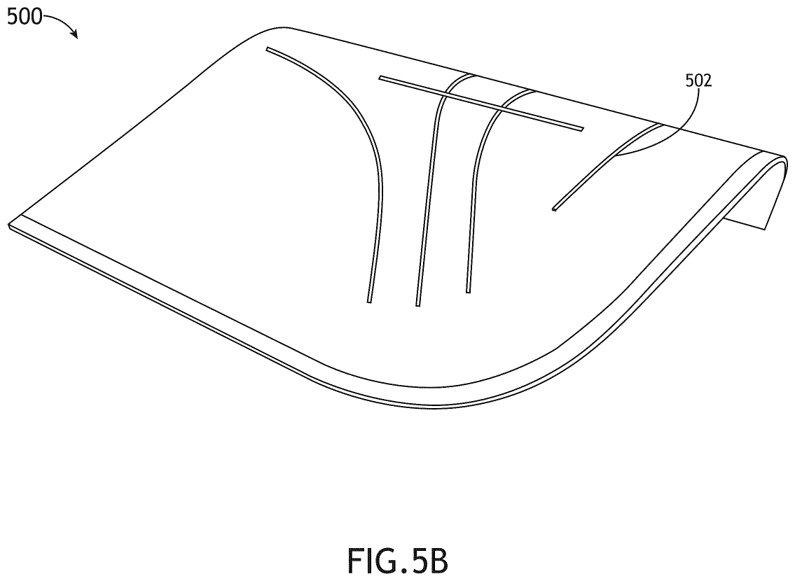

Referring to FIGS. 5A-5B, the composite shell aircraft seat assembly 200 may include one or more structural reinforcement members 500. For example, the seatback sections 206 of the composite shell aircraft seat assembly 200 may include one or more structural reinforcement members 500. In one instance, the one or more structural reinforcement members 500 may be arranged in a high lumbar section 501 of the seatback section 206 to provide tailored structural reinforcement. In a non-limiting example, automated fiber placement (AFP) stiffening composite techniques may be used for integral strengthening of seat backs, such as arm loading and tray tables.

The one or more structural reinforcement members 500 may include one or more gauged ribs 502. For example, the one or more one or more structural reinforcement members 500 may include one or more thin gauged ribs 502 formed of one or more fiber-reinforcement materials (e.g., carbon fiber, or the like). It is contemplated herein that the one or more gauged ribs 502 may be fabricated (or applied to the composite shell aircraft seat assembly 200) via any suitable technique such as, but not limited to, robotic lay-up, in-situ lay-up, automated fiber placement, tape lay-up, molded thermoplastics, bonded and sized composite components, or the like. Further it is contemplated herein that the thin gauged ribs 502 may be sized by a variety of proprietary analytical and mathematical methods. In this regard, the strength and skin thickness of the ribs may be adjusted based on the three-dimensional (3D) structural strength needed.

It is contemplated herein that by using the capacity of composite construction to deliver tailored structural requirements (e.g., strength, stiffness, energy absorption, or the like) in different areas based on the amount and layup of fiber reinforced materials, the aircraft seat 202 is able to deliver functionality for the passenger as well as a structural response to highest (e.g., 16G) loads, through the tailored application of unidirectional (e.g., carbon) fibers in specific areas (e.g., high lumbar) of the seatback/diaphragm zone. As such, the structure of the seat may be dependent on the ability to place the materials in the correct load path orientations, unlike more homogenous and cantilevered metallic structures (as shown in FIG. 1).

It is noted the composite shell aircraft seat assembly 200 may be configured to work with any aircraft seat 202 and/or any set of components in the aircraft seat 202. For example, the composite shell aircraft seat assembly 200 may be configured to take into account any changes in shape of the components of the aircraft seat 202 (e.g., within an x-y plane forming a seating surface for an occupant), where the changes in shape may be caused by or otherwise dependent on the location of the aircraft seat 202 within the aircraft cabin.

Although the disclosure has been described with reference to the embodiments illustrated in the attached drawing figures, equivalents may be employed and substitutions made herein without departing from the scope of the claims. Components illustrated and described herein are merely examples of a system/device and components that may be used to implement embodiments of the disclosure and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A composite seat frame assembly for a seat, the composite seat frame assembly comprising:
a seat pan section; and
a seatback section;
wherein the seat pan section and the seatback section are integrated to form a seat bench,
wherein the seat bench includes a single composite member formed of one or more composite materials,
wherein a passenger load applied to the seat bench is transferred from a seat belt shackle of the seat to a seat track on a floor.

2. The composite seat frame assembly of claim 1, further comprising:
a leg panel section, wherein the leg panel section is integrated with the seat pan section to form the seat bench.

3. The composite seat frame assembly of claim 2, wherein one or more composite legs are at least one of coupled to or integrated with a portion of at least one of the seat pan section, the seatback section, or the leg panel section.

4. The composite seat frame assembly of claim 2, further comprising:
one or more side panels.

5. The composite seat frame assembly of claim 4, wherein the one or more side panels are configured to couple to at least one of the seat pan section, the seatback section, or the leg panel section.

6. The composite seat frame assembly of claim 4, wherein the one or more side panels are integrated with the seat pan section, the seatback section, and the leg panel section to form the seat bench.

7. The composite seat frame assembly of claim 4, wherein the one or more side panels include one or more openings.

8. The composite seat frame assembly of claim 1, further comprising:
one or more structural beams.

9. The composite seat frame assembly of claim 8, wherein the one or more structural beams have a shallow sinusoidal shape, wherein the one or more structural beams are configured coupled to a rear portion of the seat pan section.

10. The composite seat frame assembly of claim 1, wherein one or more portions of the seatback section include one or more gauged ribs to provide tailored structural reinforcement.

11. The composite seat frame assembly of claim 10, wherein the one or more gauged ribs include one or more fiber reinforced composite ribs coupled to the one or more portions of the seatback section via robotic lay-up.

12. The composite seat frame assembly of claim 1, wherein the one or more composite materials of the single composite member includes carbon fiber including at least one of a thermoplastic matrix or a thermoset matrix.

13. The composite seat frame assembly of claim 12, wherein the single composite member of the seat bench is fabricated via stamping.

14. The composite seat frame assembly of claim 2, wherein the leg panel section includes one or more kick panels.

15. An aircraft seat, the aircraft seat comprising:
a composite shell comprising:
a seat pan section; and
a seatback section;
wherein the seat pan section and the seatback section are integrated to form a seat bench;
wherein the seat bench includes a single composite member formed of one or more composite materials; and
a base assembly coupled to the seat bench, wherein the base assembly is configured to couple to a floor of an aircraft cabin, wherein the base assembly comprises:
a leg sub-assembly including at least a front leg and a rear leg,
wherein the front leg is configured to couple to a front portion of the seat pan section,
wherein the rear leg is configured to couple to a rear portion of the seat pan section,
wherein a passenger load applied to the seat bench is transferred from a seat belt shackle of the aircraft seat to a seat track on the floor of the aircraft cabin.

16. The aircraft seat of claim 15, wherein at least one of the front leg or the rear leg are formed of the one or more composite materials or one or more additional composite materials.

17. The aircraft seat of claim 15, wherein the composite shell further comprises:
a leg panel section, wherein the leg panel section is integrated with the seat pan section to form the seat bench.

18. The aircraft seat of claim 17, further comprising:
one or more side panels, wherein the one or more side panels are configured to couple to at least one of the seat pan section, the seatback section, or the leg panel section.

19. The aircraft seat of claim 15, further comprising:
one or more structural beams, wherein the one or more structural beams have a shallow sinusoidal shape, wherein the one or more structural beams are configured coupled to a rear portion of the seat pan section.

20. The aircraft seat of claim 15, wherein one or more portions of the seatback section include one or more gauged ribs to provide tailored structural reinforcement.
